(19) United States
(12) Patent Application Publication
(10) Pub. No.: US 2014/0063418 A1
(43) Pub. Date: Mar. 6, 2014

(54) VIEWING ANGLE COMPENSATION ELEMENT, VERTICAL ALIGNMENT LIQUID CRYSTAL DISPLAY PANEL AND LIQUID CRYSTAL DISPLAY DEVICE

(71) Applicant: BOE TECHNOLOGY GROUP CO., LTD., Beijing (CN)

(72) Inventor: Weili Zhao, Beijing (CN)

(73) Assignee: BOE TECHNOLOGY GROUP CO., LTD., Beijing (CN)

(21) Appl. No.: 13/946,092

(22) Filed: Jul. 19, 2013

(30) Foreign Application Priority Data
Aug. 31, 2012 (CN) 201220443909.0

(51) Int. Cl. G02F 1/13363

(52) U.S. Cl. CPC G02F 1/13363
USPC 349/96

(57) ABSTRACT

The disclosure discloses a viewing angle compensation element applied to a VA-LCD panel. The VA-LCD panel comprises a liquid crystal cell and an upper polarizer and a lower polarizer which are respectively disposed on the upper side and the lower side of the liquid crystal cell. The viewing angle compensation element comprises a negative C phase retardation compensation film and a biaxial phase retardation compensation film, wherein the negative C phase retardation compensation film(s) is arranged between the liquid crystal cell and one of the upper polarizer and the lower polarizer, and the biaxial phase retardation compensation film is arranged between the liquid crystal cell and the lower polarizer.

### BACKGROUND

Embodiments of the disclosure relate to a viewing angle compensation element, a VA-LCD (Vertical Alignment-Liquid Crystal Display) panel and an LCD (Liquid Crystal Display) device.

In the case of being not energized, a VA-LCD takes on a black state (i.e., dark state) at a normal view angle, namely a viewing angle perpendicular to a display surface, and may have the problem of light leakage at an oblique angle. The reasons of dark-state light leakage are as follows: on one hand, an upper polarizer and a lower polarizer are not orthogonal to each other for the oblique angle; and on the other hand, vertically aligned liquid crystals have the problem of in-plane retardation for the oblique angle. Dark-state light leakage is the main reason for a reduced contrast ratio and a poor viewing angle property of LCDs.

In order to solve the above problem, one or more first compensation films (positive A phase retardation compensation films) meeting the condition of nₓ>n_{y}=n_{z}, one or more first compensation films (negative A phase retardation compensation films) meeting the condition of nₓ<n_{y}=n_{z}, and one or more second compensation films (negative C phase retardation compensation films) meeting the condition of nₓ=n_{y}>n_{z} are adopted by those skilled in the art to reduce the dark-state light leakage of the VA-LCD, and here nₓ and n_{y} represent the in-plane refractive index of the compensation films, and n_{z} represents the thickness refractive index (that is). However, the negative A phase retardation compensation films are difficult to achieve technically, and therefore a good compensation mode is needed under the condition of existing parameters of the compensation films.

### SUMMARY

In one aspect, the disclosure provides a viewing angle compensation element applied to a VA-LCD panel. The VA-LCD panel comprises a liquid crystal cell and an upper polarizer and a lower polarizer which are respectively disposed on the upper side and the lower side of the liquid crystal cell. The viewing angle compensation element comprises a negative C phase retardation compensation film and a biaxial phase retardation compensation film, wherein the negative C phase retardation compensation film(s) is arranged between the liquid crystal cell and one of the upper polarizer and the lower polarizer, and the biaxial phase retardation compensation film is arranged between the liquid crystal cell and the lower polarizer.

In one example, the viewing angle compensation element further comprises a second biaxial phase retardation compensation film arranged between the liquid crystal cell and the upper polarizer.

In one example, the negative C phase retardation compensation film is arranged between the liquid crystal cell and the biaxial phase retardation compensation film.

In one example, the negative C phase retardation compensation film is arranged between the liquid crystal cell and the second biaxial phase retardation compensation film.

In one example, the biaxial phase retardation compensation film meets a condition of N_{z}>1, where N_{z} is a biaxial factor.

In one example, a slow axis of the biaxial phase retardation compensation film is orthogonal to an absorption axis of the lower polarizer.

In one example, the second biaxial phase retardation compensation film meets a condition of N_{z}>1, where N_{z} is a biaxial factor.

In one example, a slow axis of the second biaxial phase retardation compensation film is orthogonal to an absorption axis of the lower polarizer.

In one example, in the biaxial phase retardation compensation film, nₓ>n_{y}>n_{z}.

In one example, the biaxial phase retardation compensation film meets conditions of 50 nm≦Rₑ≦200 nm and −50 nm≦Rₜₕ≦−200 nm.

In one example, in the second biaxial phase retardation compensation film, nₓ>n_{y}>n_{z}.

In one example, the second biaxial phase retardation compensation film meets conditions of 50 nm≦Rₑ≦200 nm and −50 nm≦Rₜₕ≦−200 nm.

In one example, the negative C phase retardation compensation film meets a condition of 100 nm≦Rₜₕ≦400 nm.

In one example, the viewing angle compensation element further comprises a second negative C phase retardation compensation film arranged between the liquid crystal cell and the other of the upper polarizer and the lower polarizer.

In one example, the second negative C phase retardation compensation film meets a condition of 100 nm≦Rₜₕ≦400 nm.

In another aspect, the disclosure also provides a VA-LCD panel, which comprises a liquid crystal cell, an upper polarizer and a lower polarizer which are respectively disposed on the upper side and the lower side of the liquid crystal cell, and any one of the above-mentioned viewing angle compensation elements applied to the VA-LCD panel.

In still another aspect, the disclosure also provides an LCD device, which comprises a VA-LCD panel provided above.

Further scope of applicability of the present disclosure will become apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the following detailed description.

### BRIEF DESCRIPTION OF THE DRAWINGS

The present disclosure will become more fully understood from the detailed description given hereinafter and the accompanying drawings which are given by way of illustration only, and thus are not limitative of the present disclosure and wherein:

FIG. 1 is a schematic structural view of a VA-LCD panel without compensation films;

FIG. 2 is an optical simulation dark-state brightness distribution diagram of the VA-LCD panel without the compensation films;

FIG. 3 is a schematic structural view of a VA-LCD panel in an embodiment 1 of the disclosure;

FIG. 4 is a schematic structural view of a VA-LCD panel in an embodiment 2 of the disclosure;

FIG. 5 is an optical simulation dark-state brightness distribution diagram of the VA-LCD panel in the embodiments 1 and 2 of the disclosure.

FIG. 6 is a schematic structural view of a VA-LCD panel in an embodiment 3 of the disclosure;

FIG. 7 is an optical simulation dark-state brightness distribution diagram of the VA-LCD panel in the embodiment 3 of the disclosure.

FIG. 8 is a schematic structural view of a VA-LCD panel in an embodiment 4 of the disclosure;

FIG. 9 is a schematic structural view of a VA-LCD panel in an embodiment 5 of the disclosure;

FIG. 10 is an optical simulation dark-state brightness distribution diagram of the VA-LCD panel in the embodiments 4 and 5 of the disclosure.

FIG. 11 is a schematic structural view of a VA-LCD panel in an embodiment 6 of the disclosure; and

FIG. 12 is an optical simulation dark-state brightness distribution diagram of the VA-LCD panel in the embodiment 6 of the disclosure.

### REFERENCE NUMERALS

1: liquid crystal cell; 2: upper polarizer; 3: lower polarizer; 4: first negative C phase retardation compensation film; 5: first biaxial phase retardation compensation film; 6: second negative C phase retardation compensation film; 7: second biaxial phase retardation compensation film.

### DETAILED DESCRIPTION

Further detailed description is given below to the specific implementations of the disclosure with the attached drawings and embodiments. The embodiments below are intended to illustrate the implementations of the disclosure and not to limit the scope of the disclosure.

Unless otherwise defined, the technical or scientific terminology used herein should have the same meaning as commonly understood by one of ordinary skill in the art to which this invention belongs. “First”, “second” and the like used in specification and claims of the patent application of the invention do not show any order, number or importance, but are only used to distinguish different constituent parts. Likewise, the phrase such as “a,” “an,” “the” or the like does not indicate limitation in number, but specifies the presence of at least one. The phrase such as “comprise,” “comprising,” “include,” “including”, “contain” or the like means that an element or article ahead of this term encompasses element(s) or article(s) listed behind this term and its(their) equivalents, but does not preclude the presence of other elements or articles. The phrase such as “connection,” “connected,” or the like is not limited to physical or mechanical connection, but can include electrical connection, whether directly or indirectly. “Upper,” “lower,” “left,” “right” or the like is only used to describe a relative positional relationship, and when the absolute position of a described object is changed, the relative positional relationship might also be changed accordingly.

A compensation film is a film with anisotropy in refractive index, namely refractive indexes nₓ, n_{y} and n_{z} of the film in three directions that are orthogonal to each other are not completely identical, where nₓ represents the refractive index in the direction of an in-plane retardation axis of a biaxial phase retardation compensation film, n_{y} represents the refractive index in the direction perpendicular to the in-plane retardation axis of the biaxial phase retardation compensation film, and n_{z} represents the refractive index in the direction perpendicular to a film plane of the biaxial phase retardation compensation film. At a normal view angle, the film does not have retardation so that the contrast ratio may not be affected. At an oblique view angle, the film can compensate the retardation of liquid crystals so that the light leakage can be reduced and the contrast ratio can be improved. The compensation films can be made of a film material with isotropy in refractive index, and for example can be obtained by the process of MD (Machine Direction) stretching, TD (Transverse Direction) stretching, or TD retraction on the material such as TAC, PMMA, PC, Acryl or the like. Therefore, the original material with isotropy in refractive index can possess anisotropy in refractive index according to different manufacturing processes. In a biaxial phase retardation compensation film, nx>ny>nz; and in a negative C compensation film, nx=ny>nz.

### Embodiments 1 and 2

FIG. 1 is a schematic structural view of a VA-LCD panel without compensation films. As illustrated in FIG. 1, an upper polarizer 2 and a lower polarizer 3 are respectively disposed on the upper side and the lower side of a liquid crystal cell 1, and absorption axes of the upper polarizer 2 and the lower polarizer 3 are orthogonal to each other. For example, the absorption axis of the lower polarizer 3 is at 90 degrees (Y-axis direction in the figure) and the absorption axis of the upper polarizer 2 is at 0 degree (X-axis direction in the figure). The liquid crystal cell 1 that is filled with positive or negative liquid crystals is arranged between the upper polarizer and the lower polarizer. For example, the pretilt angle θ of the liquid crystals is set to be between 89 and 90 degrees; the cell gap (thickness) of the liquid crystal cell 1 is between 3 and 5 micrometers; and the in-plane retardation at the wavelength of 550 nanometers is between 300 and 600 nanometers.

The liquid crystal cell 1, for instance, is formed by two substrates which are parallel to each other and cell-assembled together by sealant coated along the edges of the substrates. Spherical or post spacers may be distributed in the liquid crystal cell 1 so as to maintain the cell gap of the liquid crystal cell 1. The upper polarizer 1 and the lower polarizer 3 may be distributed inside or outside the substrates and usually disposed outside the substrates with respect to the liquid crystal cell 1.

The pretilt angles of the liquid crystals are controlled by alignment films formed on the substrates constituting the liquid crystal cell 1. The alignment films are subjected to a rubbing process so as to form multiple fine grooves on their surfaces or the alignment films of polymers are subjected to a photo alignment process to have their surfaces transformed into an ordered arrangement.

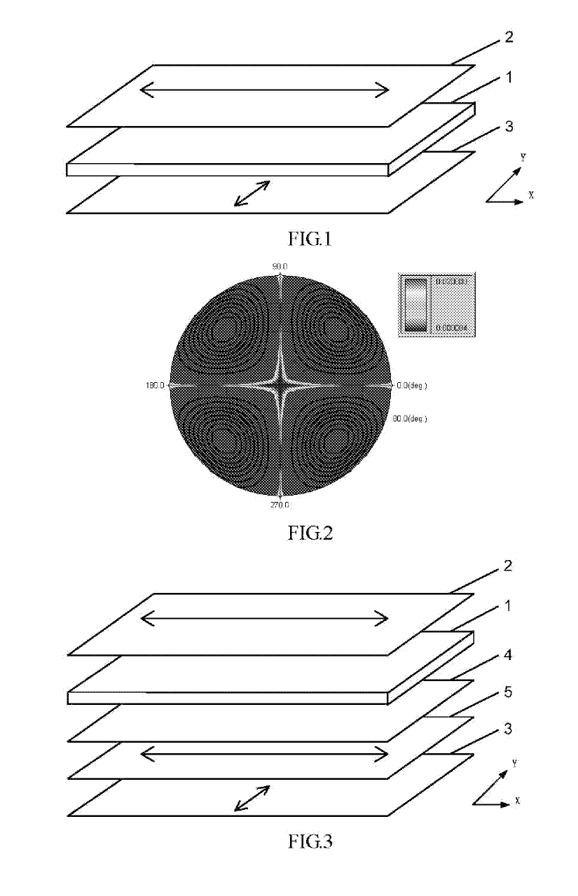

FIG. 2 is an optical simulation dark-state brightness distribution diagram of the VA-LCD panel without the compensation films. As illustrated in FIG. 2, the VD-LCD panel without the compensation films has serious problem of dark-state light leakage. In particular, the light intensity obtained by simulation at viewing angles of 45, 135, 225 and 315 degrees achieves the maximum of 8.51 nit.

In the above example and the following embodiments of the disclosure to be described, during the simulation, the initial alignment of liquid crystals is selected to be vertical alignment and the retardation of the liquid crystals is 485 nm for the convenience of comparison. Due to the variation of optical parameters, it does not necessarily mean that the result obtained by optical simulation in the disclosure is that obtained in practice.

FIG. 3 is a schematic structural view of a VA-LCD panel in the embodiment 1. As illustrated in FIG. 3, a biaxial phase retardation compensation film and a negative C phase retardation compensation film are adopted for dark-state light leakage compensation. Absorption axes of an upper polarizer 2 and a lower polarizer 3 are orthogonal to each other. For example, the absorption axis of the lower polarizer 3 is at 90 degrees (Y-axis direction in the figure), and the absorption axis of the upper polarizer 2 is at 0 degree (X-axis direction in the figure). The liquid crystal cell 1 that is filled with positive or negative liquid crystals is arranged between the upper polarizer 2 and the lower polarizer 3. The pretilt angles θ of the liquid crystals are set to be between 89 and 90 degrees, and the cell gap (thickness) of the liquid crystal cell 1 is between 3 and 5 micrometers. Moreover, a first biaxial phase retardation compensation film 5 meeting the condition of N_{z}>1 and a first negative C phase retardation compensation film 4 are arranged in order between the lower polarizer 3 and the liquid crystal cell 1, in which N_{z} is a biaxial factor of the compensation film.

$${N}_{Z} = \frac{{n}_{x} - {n}_{z}}{{n}_{x} - {n}_{y}} = \frac{{R}_{th}}{{R}_{e}} + 0.5$$

The first negative C phase retardation compensation film 4 is disposed on the lower side of the liquid crystal cell 1, and a slow axis of the first biaxial phase retardation compensation film 5 is orthogonal to an absorption axis of the lower polarizer 3. In the first biaxial phase retardation compensation film 5, nₓ>n_{y}>n_{z}. Moreover, the first biaxial phase retardation compensation film 5 meets the conditions of 50 nm≦Rₑ≦200 nm and −50 nm≦Rₜₕ≦−200 nm, where Rₑ represents the in-plane retardation of the film plane for the biaxial phase retardation compensation film, and Rₜₕ represents the thickness retardation of the biaxial phase retardation compensation film.

$${R}_{e} = ( {n}_{x} - {n}_{y} ) \times d , \\ {R}_{th} = ( {n}_{z} - \frac{{n}_{x} + {n}_{y}}{2} ) \times d$$

where d represents the thickness of the compensation film. Furthermore, the first negative C phase retardation compensation film 4 meets the condition of 100 nm≦Rₜₕ≦400 nm.

As illustrated in FIG. 3, the first negative C phase retardation compensation film 4 and the first biaxial phase retardation compensation film 5 are arranged on the lower side of the liquid crystal cell 1, and the first negative C phase retardation compensation film 4 is arranged between the liquid crystal cell 1 and the first biaxial phase retardation compensation film 5.

FIG. 4 is a schematic structural view of a VA-LCD panel in the embodiment 2. As illustrated in FIG. 4, a biaxial phase retardation compensation film and a negative C phase retardation compensation film are also adopted for dark-state light leakage compensation. The differences of the structure as shown in FIG. 4 from the structure of the embodiment 1 as shown in FIG. 3 is as follows: the first negative C phase retardation compensation film 4 is disposed on the upper side of the liquid crystal cell 1, and the first biaxial phase retardation compensation film 5 is disposed on the upper side of the lower polarizer 3. Only the disposing positions of the first negative C phase retardation compensation film 4 and the first biaxial phase retardation compensation film 5 are changed, but the structural parameters thereof are the same as those of the embodiment 1 in FIG. 3.

FIG. 5 is an optical simulation dark-state brightness distribution diagram of the VA-LCD panel in the embodiments 1 and 2. As illustrated in FIG. 5, the embodiments 1 and 2 have identical dark-state brightness distribution. The dark-state light leakage of the VA-LCD panel with one biaxial phase retardation compensation film and one negative C phase retardation compensation film is greatly improved. The light intensity obtained by simulation at the viewing angles of 45, 135, 225 and 315 degrees is 0.0192 nit, so the light leakage is obviously reduced compared with the structure of the VA-LCD panel without the compensation films as shown in FIG. 1.

### Embodiment 3

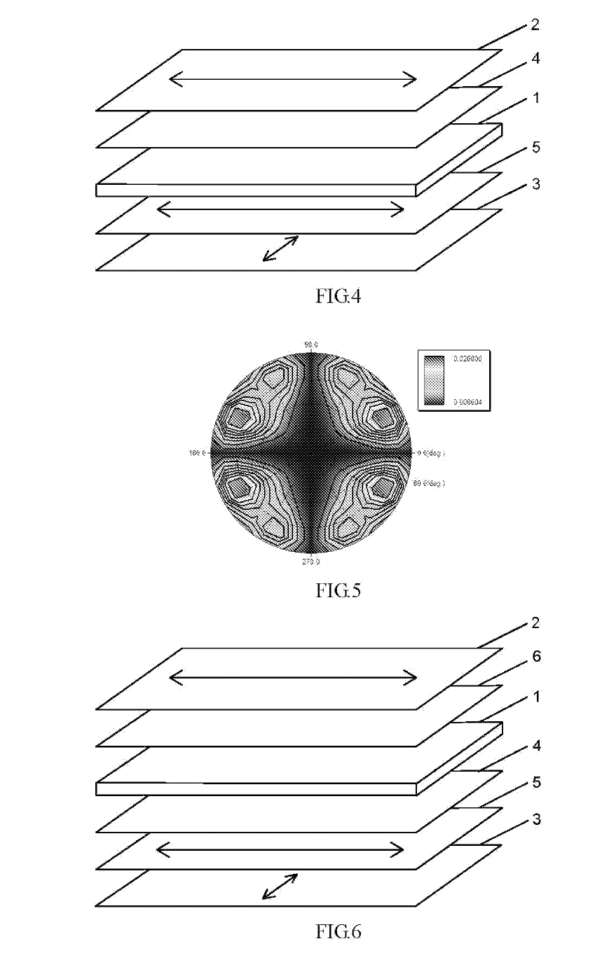

FIG. 6 is a schematic structural view of a VA-LCD panel in the embodiment 3. As illustrated in FIG. 6, two negative C phase retardation compensation films and a biaxial phase retardation compensation film are adopted for dark-state light leakage compensation. The structure of the VA-LCD panel of this embodiment is as follows: a second negative C phase retardation compensation film 6 is additionally arranged on the upper side of the liquid crystal cell 1 on the basis of the structure of the VA-LCD panel in the embodiment 1 as shown in FIG. 3. Both the structures and parameters of the liquid crystal cell 1, an upper polarizer 2, a lower polarizer 3, a first negative C phase retardation compensation film 4 and a first biaxial phase retardation compensation film 5 in the embodiment are the same as those of the VA-LCD panel in the embodiment 1 as shown in FIG. 3. Moreover, the performance parameters of the second negative C phase retardation compensation film 6 are also the same as those of the first negative C phase retardation compensation film 4.

More specifically, as illustrated in FIG. 6, the first negative C phase retardation compensation film 4 and the first biaxial phase retardation compensation film 5 are both arranged on the lower side of the liquid crystal cell 1, and the first negative C phase retardation compensation film 4 is arranged between the liquid crystal cell 1 and the first biaxial phase retardation compensation film 5.

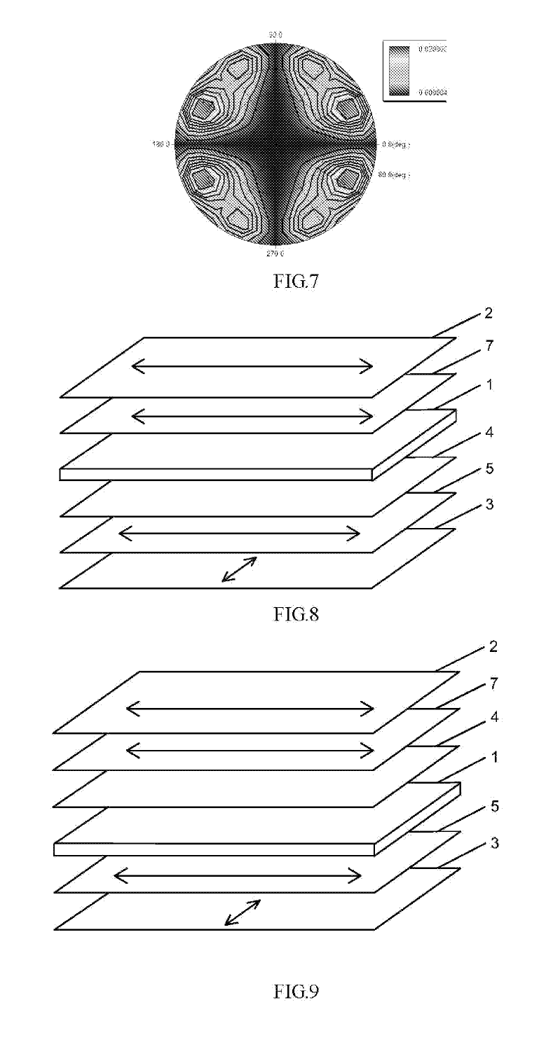

FIG. 7 is an optical simulation dark-state brightness distribution diagram of the VA-LCD panel in the embodiment 3. As illustrated in FIG. 7, the dark-state light leakage of the VA-LCD panel with one biaxial phase retardation compensation film and two negative C phase retardation compensation film is greatly improved. The light intensity obtained by simulation at the viewing angles of 45, 135, 225 and 315 degrees is 0.0192 nit, so the light leakage is obviously reduced compared with the structure of the VA-LCD panel without the compensation films as shown in FIG. 1.

### Embodiments 4 and 5

FIG. 8 is a schematic structural view of a VA-LCD panel in the embodiment 4. As illustrated in FIG. 8, a negative C phase retardation compensation film and two biaxial phase retardation compensation films are adopted for dark-state light leakage compensation. The structure of the VA-LCD panel as shown in FIG. 8 is as follows: a second biaxial phase retardation compensation film 7 is additionally arranged on the upper side of the liquid crystal cell 1 on the basis of the structure of the VA-LCD panel in the embodiment 1 as shown in FIG. 3. Both the structures and parameters of the liquid crystal cell 1, an upper polarizer 2, a lower polarizer 3, a first negative C phase retardation compensation film 4 and a first biaxial phase retardation compensation film 5 as shown in FIG. 8 are the same as those of the VA-LCD panel in the embodiment 1 as shown in FIG. 3. Moreover, the performance parameters of the second biaxial phase retardation compensation film 7 are also the same as those of the first biaxial phase retardation compensation film 5, and a slow axis of the second biaxial phase retardation compensation film 7 is orthogonal to an absorption axis of the lower polarizer 3.

FIG. 9 is a schematic structural view of a VA-LCD panel in the embodiment 5. As illustrated in FIG. 9, a negative C phase retardation compensation film and two biaxial phase retardation compensation films are also adopted for dark-state light leakage compensation. The structure of the VA-LCD panel as shown in FIG. 9 is as follows: a second biaxial phase retardation compensation film 7 is additionally arranged between an upper polarizer 2 and the first negative C phase retardation compensation film 4 on the basis of the structure of the VA-LCD panel in the embodiment 2 as shown in FIG. 4. Both the structures and parameters of a liquid crystal cell 1, the upper polarizer 2, a lower polarizer 3, the first negative C phase retardation compensation film 4 and a first biaxial phase retardation compensation film 5 are the same as those of the VA-LCD panel in the embodiment 2 as shown in FIG. 4. Moreover, the performance parameters of the second biaxial phase retardation compensation film 7 are also the same as those of the first biaxial phase retardation compensation film 5, and a slow axis of the second biaxial phase retardation compensation film 7 is orthogonal to an absorption axis of the lower polarizer 3.

As illustrated in FIG. 8, the first negative C phase retardation compensation film 4 and the first biaxial phase retardation compensation film 5 are arranged on the lower side of the liquid crystal cell 1 together, and the first negative C phase retardation compensation film 4 is arranged between the liquid crystal cell 1 and the first biaxial phase retardation compensation film 5. As illustrated in FIG. 9, both the first negative C phase retardation compensation film 4 and the second axial phase retardation compensation film 7 are arranged on the upper side of the liquid crystal cell 1, and the first negative C phase retardation compensation film 4 is arranged between the liquid crystal cell 1 and the second biaxial phase retardation compensation film 7.

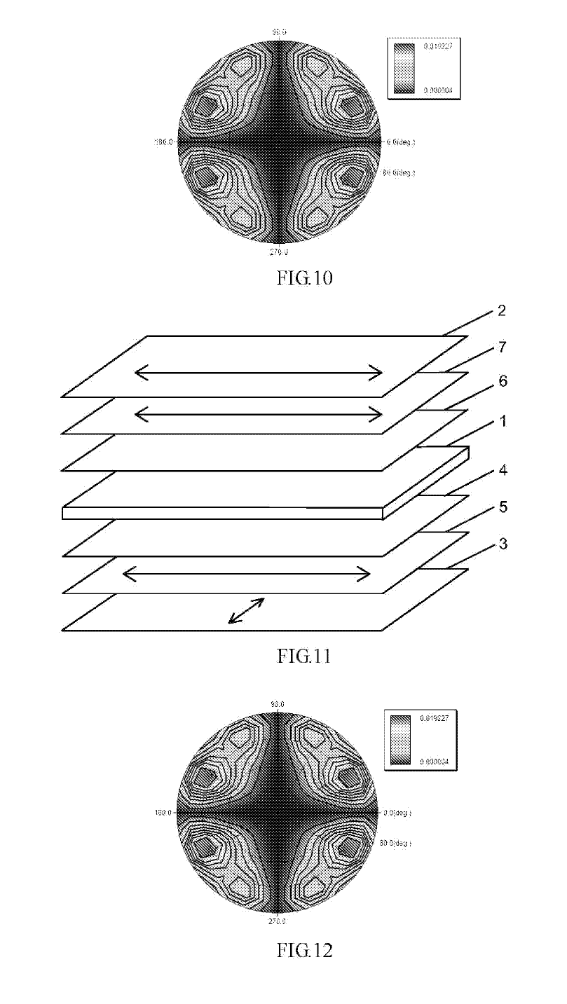

FIG. 10 is an optical simulation dark-state brightness distribution diagram of the VA-LCD panel in the embodiments 4 and 5. As illustrated in FIG. 10, the embodiments 4 and 5 have identical dark-state brightness distribution. The dark-state light leakage of the VA-LCD panel with two biaxial phase retardation compensation film and one negative C phase retardation compensation film is greatly improved. The light intensity obtained by simulation at the viewing angles of 45, 135, 225 and 315 degrees is 0.0284 nit, so the light leakage is obviously reduced compared with the structure of the VA-LCD panel without the compensation films as shown in FIG. 1.

### Embodiment 6

FIG. 11 is a schematic structural view of a VA-LCD panel in the embodiment 6. As illustrated in FIG. 11, two negative C phase retardation compensation films and two biaxial phase retardation compensation films are adopted for dark-state light leakage compensation. The structure of the VA-LCD panel of the embodiment may be improved on the basis of the structures of the VA-LCD panels in the embodiments 3, 4 and 5 respectively. On the basis of the structure of the embodiment 3 as shown in FIG. 6, a second biaxial phase retardation compensation film 7 is additionally arranged in this embodiment between the upper polarizer 2 and the second negative C phase retardation compensation film 6. On the basis of the structure of the embodiment 4 as shown in FIG. 8, the second negative C phase retardation compensation film 6 is additionally arranged in the embodiment between the liquid crystal cell 1 and the second biaxial phase retardation compensation film 7. On the basis of the structure of the embodiment 5 as shown in FIG. 9, another negative C phase retardation compensation film 4 is arranged in this embodiment between the liquid crystal cell 1 and a first biaxial phase retardation compensation film 5. The performance parameters of the negative C phase retardation compensation films and the biaxial phase retardation compensation films in this embodiment are completely identical to those of the above embodiments.

As illustrated in FIG. 11, the first negative C phase retardation compensation film 4 and the first biaxial phase retardation compensation film 5 are arranged on the lower side of the liquid crystal cell 1; the second negative C phase retardation compensation film 6 and the second biaxial phase retardation compensation film 7 are arranged on the upper side of the liquid crystal cell 1; the first negative C phase retardation compensation film 4 is arranged between the liquid crystal cell 1 and the first biaxial phase retardation compensation film 5; and the second negative C phase retardation compensation film 6 is arranged between the liquid crystal cell 1 and the second biaxial phase retardation compensation film 7.

FIG. 12 is an optical simulation dark-state brightness distribution diagram of the VA-LCD panel in the embodiment 6. As illustrated in FIG. 12, the dark-state light leakage of the VA-LCD panel with two biaxial phase retardation compensation films and two negative C phase retardation compensation films is greatly improved. The light intensity obtained by simulation at the viewing angles of 45, 135, 225 and 315 degrees is 0.0284 nit, so the light leakage is obviously reduced compared with the structure of the VA-LCD panel without the compensation films as shown in FIG. 1.

As seen from the above embodiments, the embodiments of the disclosure adopt the biaxial phase retardation compensation film(s) with the biaxial factor of more than 1 and the negative C phase retardation compensation film(s) to reduce the dark-state light leakage of the VA-LCD panel at an oblique view angle. The compensation mode can greatly reduce the dark-state light leakage, improves the contrast ratio and widens the viewing angle. Moreover, both the in-plane retardation and the thickness retardation of the compensation films adopted are within the current achievable range, so the compensation mode has strong feasibility and practical significance.

The embodiments of the disclosure being thus described, it will be obvious that the same may be varied in many ways. Such variations are not to be regarded as a departure from the spirit and scope of the disclosure, and all such modifications as would be obvious to those skilled in the art are intended to be included within the scope of the following claims.

What is claimed is:

1. A viewing angle compensation element capable of being applied to a vertical alignment-liquid crystal display (VA-LCD) panel, the VA-LCD panel comprising a liquid crystal cell and an upper polarizer and a lower polarizer respectively disposed on the upper side and the lower side of the liquid crystal cell, the viewing angle compensation element comprising:
a negative C phase retardation compensation film arranged between the liquid crystal cell and one of the upper polarizer and the lower polarizer; and
a biaxial phase retardation compensation film arranged between the liquid crystal cell and the lower polarizer.

2. The viewing angle compensation element according to claim 1, further comprising a second biaxial phase retardation compensation film arranged between the liquid crystal cell and the upper polarizer.

3. The viewing angle compensation element according to claim 1, wherein the negative C phase retardation compensation film is arranged between the liquid crystal cell and the biaxial phase retardation compensation film.

4. The viewing angle compensation element according to claim 2, wherein the negative C phase retardation compensation film is arranged between the liquid crystal cell and the second biaxial phase retardation compensation film.

5. The viewing angle compensation element according to claim 1, wherein the biaxial phase retardation compensation film meets a condition of N_{z}>1, where N_{z} is a biaxial factor.

6. The viewing angle compensation element according to claim 1, wherein a slow axis of the biaxial phase retardation compensation film is orthogonal to an absorption axis of the lower polarizer.

7. The viewing angle compensation element according to claim 2, wherein the second biaxial phase retardation compensation film meets a condition of N_{z}>1, where N_{z} is a biaxial factor.

8. The viewing angle compensation element according to claim 2, wherein a slow axis of the second biaxial phase retardation compensation film is orthogonal to an absorption axis of the lower polarizer.

9. The viewing angle compensation element according to claim 1, wherein in the biaxial phase retardation compensation film, nₓ>n_{y}>n_{z}, where nₓ represents a refractive index in the direction of an in-plane retardation axis of the biaxial phase retardation compensation film; n_{y} represents a refractive index in the direction perpendicular to the in-plane retardation axis of the biaxial phase retardation compensation film; and n_{z} represents a refractive index in the direction perpendicular to a film plane of the biaxial phase retardation compensation film.

10. The viewing angle compensation element according to claim 9, wherein the biaxial phase retardation compensation film meets conditions of −50 nm≦Rₜₕ≦−200 nm and −50 nm≦Rₜₕ≦−200 nm, where Rₑ represents in-plane retardation of the film plane for the biaxial phase retardation compensation film, and Rₜₕ represents thickness retardation of the biaxial phase retardation compensation film.

11. The viewing angle compensation element according to claim 2, wherein in the second biaxial phase retardation compensation film, nₓ>n_{y}>n_{z}, where nₓ represents a refractive index in the direction of an in-plane retardation axis of the second biaxial phase retardation compensation film; n_{y} represents a refractive index in the direction perpendicular to the in-plane retardation axis of the second biaxial phase retardation compensation film; and n_{z} represents a refractive index in the direction perpendicular to a film plane of the second biaxial phase retardation compensation film.

12. The viewing angle compensation element according to claim 11, wherein the second biaxial phase retardation compensation film meets conditions of 50 nm≦Rₑ≦200 nm and −50 nm≦Rₜₕ≦−200 nm, where Rₑ represents in-plane retardation of the film plane for the second biaxial phase retardation compensation film, and Rₜₕ represents thickness retardation of the second biaxial phase retardation compensation film.

13. The viewing angle compensation element according to claim 1, wherein the negative C phase retardation compensation film meets a condition of 100 nm≦Rₜₕ≦400 nm, where Rₜₕ represents thickness retardation of the negative C phase retardation compensation film.

14. The viewing angle compensation element according to claim 1, further comprising a second negative C phase retardation compensation film arranged between the liquid crystal cell and the other of the upper polarizer and the lower polarizer.

15. The viewing angle compensation element according to claim 14, wherein the second negative C phase retardation compensation film meets a condition of 100 nm≦Rₜₕ≦400 nm, where Rₜₕ represents thickness retardation of the negative C phase retardation compensation film.

16. The viewing angle compensation element according to claim 2, further comprising a second negative C phase retardation compensation film arranged between the liquid crystal cell and the other of the upper polarizer and the lower polarizer.

17. The viewing angle compensation element according to claim 16, wherein the second negative C phase retardation compensation film meets a condition of 100 nm≦Rₜₕ≦400 nm, where Rₜₕ represents thickness retardation of the negative C phase retardation compensation film.

18. A vertical alignment-liquid crystal display (VA-LCD) panel, comprising a viewing angle compensation element, a liquid crystal cell and an upper polarizer and a lower polarizer respectively disposed on the upper side and the lower side of the liquid crystal cell, wherein the viewing angle compensation element is the viewing angle compensation element according to claim 1.

19. A liquid crystal display (LCD) device, comprising the VA-LCD panel according to claim 18.
